(19) United States
(12) Patent Application Publication
(10) Pub. No.: US 2006/0017690 A1
(43) Pub. Date: Jan. 26, 2006

(54) Apparatus and method for motion detection in three dimensions

(75) Inventors: David Kuiken, Round Rock, TX (US); Rick Smith, Round Rock, TX (US)

Correspondence Address: IBM CORPORATION;INTELLECTUAL PROPERTY LAW, 11400 BURNET ROAD, AUSTIN, TX, 78758, US

(73) Assignee: International Business Machines Corporation, Armonk, NY (US)

(21) Appl. No.: 10/897,223

(22) Filed: Jul. 22, 2004

(51) Int. Cl. G09G 5/00

(52) U.S. Cl. 345/156

(57) ABSTRACT

Apparatus and method are disclosed for sensing a desired cursor position by detecting disturbance due to acceleration in each of three piezoelectric crystals located in a user movable housing. Crystals corresponding to X, Y, and Z dimensions are connected to means for converting disturbance due to acceleration into a voltage which is thereafter converted to appropriate signal format for implementation by a computer. The apparatus may be wired or wireless and in the form of a conventional mouse or a user wearable device.

### BACKGROUND OF THE INVENTION

1. Field of the Invention

The present invention relates to sensing motion in three dimensions. More particularly, it relates to processing a signal developed from the acceleration of piezoelectric crystals located in a computer pointing device such as a mouse or the like in order to determine a user desired position.

2. Description of the Prior Art

Prior art computer mouse pointing devices of varying designs are known. Many require contact with a relatively planar surface because they depend on detecting movement and motion by sensing distance and direction on the surface in contact with the mouse. Both wired and wireless versions of this type of prior art device are known.

Piezoelectric crystals and their properties are known, and their use is widespread. U.S. Patent Publication 2001/0012002 A1, Aug. 9, 2001 to Tosaya describes a piezoelectric transducer having utility in a transmitter pen data entry device for an electronic tablet or whiteboard. This reference also discloses a stationary, finger actuated pointing device which is capable of performing a three-dimensional (3D) input operation using an apparatus having light emitting and light receiving elements.

Problems arise in prior computer pointing devices due to the need to have the devices in contact with a planar surface. This need often gives rise to user difficulties. Hand and arm motion may cause physical problems for some people. There is a need for good human factors, especially for high volume users and those with arthritic or similar impairment which limit comfortable movement. As ever, speed and accuracy are sought after features for any pointing device.

### BRIEF SUMMARY OF THE INVENTION

In a preferred embodiment, the present invention overcomes the aforementioned shortcomings in the prior art by providing apparatus and a method for sensing 3D motion utilizing the properties of piezoelectric crystals. Including such crystals as the basis of motion detection removes the necessity of maintaining a computer pointing device in contact with a planar surface. The invention proceeds from the recognition of a new use of the signal arising from deformation of a piezoelectric crystal experiencing acceleration. That signal may be converted into typical pointing device computer signals for positioning a cursor for clicking and the like. The inventive method of measuring motion enables new types of computer input devices.

### BRIEF DESCRIPTION OF THE DRAWING

The various aspects, features and advantages of the inventive apparatus and method will be evident from the detailed description appearing below taken in conjunction with the following drawing figures in which like reference numerals are used throughout to indicate the same elements and wherein:

FIG. 1 depicts a schematic view of a mouse pointing device equipped with piezoelectric crystals in accordance with the present invention;

FIG. 2 is a block diagram of a circuit for obtaining a voltage output from piezoelectric crystal acceleration;

FIG. 3 is a plan view of crystal 14;

FIG. 4 illustrates conversion of crystal disturbance into a voltage by showing an expansion of block 28 of FIG. 1;

FIG. 5 compares operation of a prior art two-dimensional mouse with operation of the 3D mouse of the present invention;

FIG. 6 graphically shows the relation between acceleration, time and distance for any piezoelectric crystal included in the present invention;

FIGS. 7A and 7B graphically depict use and performance of the present invention; and

FIG. 8 illustrates a 3D space in which a user may navigate.

### DETAILED DESCRIPTION OF THE INVENTION

Refer now to FIG. 1. Shown is a typical mouse housing 10 connected by cord 12 as is well understood to a computer (not shown). A piezoelectric crystal 14 is depicted for sensing motion in the X direction. In a similar manner piezoelectric crystal 16 is provided for Y direction sensing; and piezoelectric crystal 18 is provided for sensing motion in the Z direction. Each piezoelectric crystal 14, 16 and 18 is here represented as a rectangular crystal, but other crystal configurations may be successfully employed. In FIG. 1 each crystal is preferably of the same dimensions. Crystals 14 and 16 stand on one of their smaller faces and the resting surfaces are disposed 90 degrees relative to each other while crystal 18 is disposed to rest on one of its large faces. The orientation of crystal 18 relative to crystals 14 and 16 is not material to the operation of the apparatus of the invention. Similarly, if the faces of crystals 14, 16, and 18 are essentially square rather than rectangular, placement orientation with respect to each other is immaterial. Each crystal is disposed in a cavity in housing 10. Cavities 15, 17, and 19 are configured to hold crystals 14, 16, and 18, respectively, to constrain opposing faces of each crystal, which faces are orthogonal in orientation to the direction of motion for which the crystal is provided to sense.

The exact configuration of cavities 15, 17 and 19 is a matter of designer choice. What is necessary is that the force of acceleration be applied evenly across an entire face of a crystal. It should be clear that any means of placing a crystal in a movable housing, so as to constrain opposing faces of the crystal in a direction orthogonal to the direction of motion the crystal is to sense.

FIG. 2 depicts X direction piezoelectric crystal 14, which may be a quartz crystal, provided for sensing acceleration in the direction of arrow 20. Suitable piezoelectric crystals for use in the present invention are readily available. Suitable alternatives to piezoelectric crystals are piezoelectric ceramics such as Ceramic Gyros available from TOKIN.

Lines 24 and 26 connect crystal 14 to excitation and modulation detection means 28 which has an output voltage on line 30, in cord 12, representative of acceleration magnitude and direction, as will become more clear in the description of FIG. 4. Lines 24 and 26 are connected to opposing faces of crystal 14, which faces are unconstrained by cavity 15.

While FIG. 2 shows crystal 14 only, those having skill in the art will understand that similar arrangements exist for crystals 16 and 18 and that the discussion in connection with crystal 14 is applicable to the other two crystals illustrated in FIG. 1.

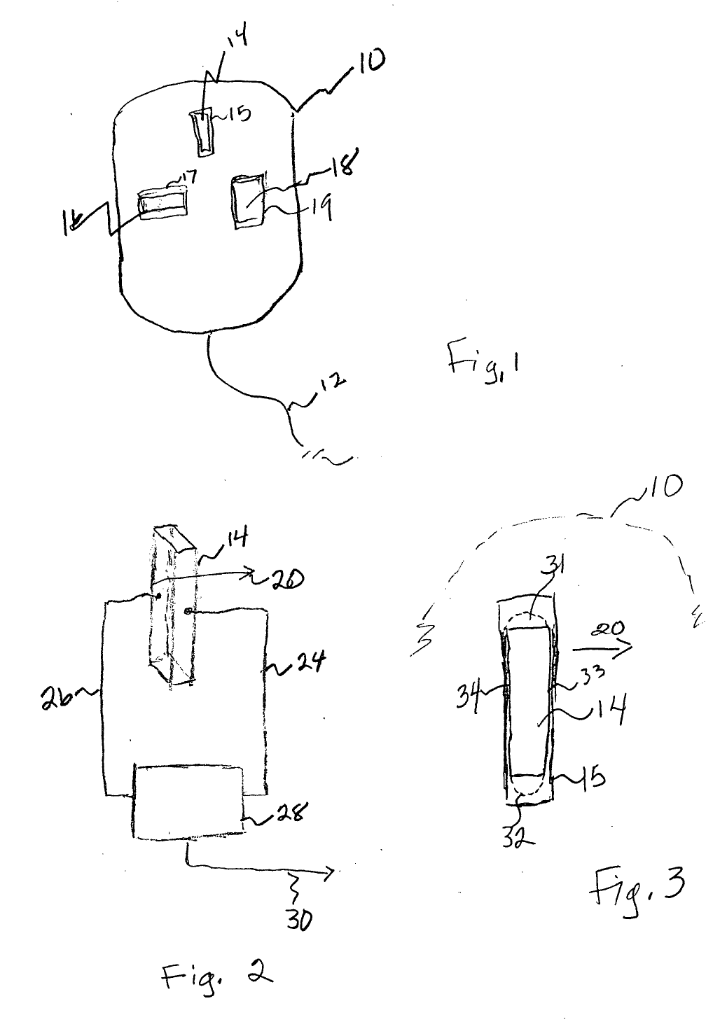

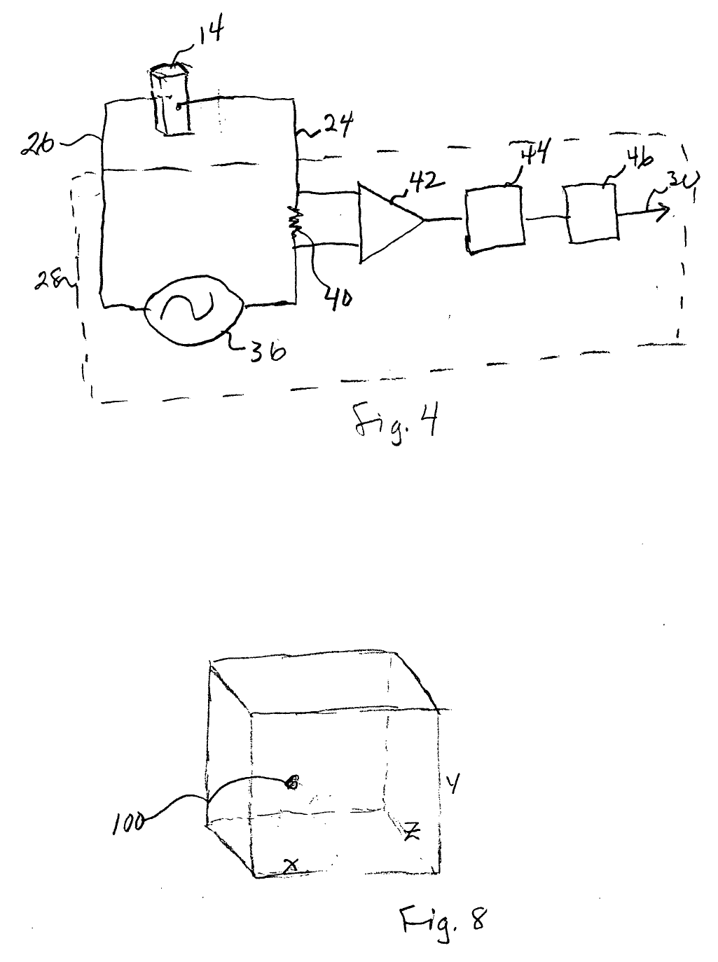

FIG. 3 is a not to scale plan view of crystal 14 showing crystal deformation during acceleration in the direction of arrow 20 (FIG. 2). The force of acceleration fa is applied evenly against faces 31 and 32 of crystal 14, which faces are constrained by sides of cavity 15 in housing 10. Dotted lines 33 and 34 indicate bulges at the end faces of crystal 14, which faces are unconstrained by walls of cavity 15 in housing 10 (FIG. 1). Crystal 14 is undergoing acceleration in the X dimension, represented by arrow 20. The deformation, bulging, of crystal 14 is the crystal disturbance which is reflected in a voltage change as detected in means 28 as described below.

FIG. 4 shows a diagram useful in understanding how excitation and modulation detection means 28 operates to convert crystal disturbance, indicative of acceleration, into a voltage. For simplicity, FIG. 4 is described in connection with crystal 14, but as with FIGS. 2 and 3, the description below is equally applicable to crystals 16 and 18.

AC oscillator 34 is provided to apply a voltage to crystal 14. Excitation by oscillator 34 combined with movement of housing 10 lead to deformation in crystal 14, which deformation causes a change in the reactance of crystal 14, and thus a change in load to oscillator 36 as sensed by resistor 40. Differential amplifier 42 senses this load change. Output from amplifier 42 is input to filter 44 for rectification and signal smoothing. Output from filter 44 is input to digitizer 46, output from which represents acceleration experienced by crystal 14.

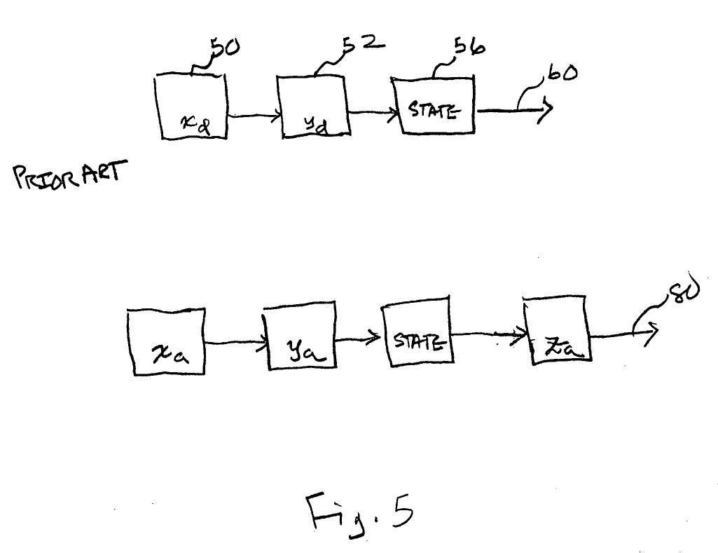

Thus, it will be appreciated that signals from each of crystals 14, 16, and 18 are processed in the same manner so that a composite signal representing digitized outputs from each are applied to conventional circuitry for transmission to a computer in wired or wireless mode. Have reference now to FIG. 5 which is a graphic comparison of the protocol stream of prior art mouse operation as a function of distance traveled by a mouse element on a planar surface with the protocol stream of the operation of a mouse incorporating the present invention. A mouse using the present invention operates as a function of the acceleration experienced by the piezoelectric crystals, detected independent of mouse location. A desired position for a standard mouse is conventionally determined by combining its mechanical displacement along the X-axis, x_{d} 50 with its displacement along the Y-axis, y_{d} 52. Added thereto is conventional button, scroll wheel, and/or other element, state information as indicated at 56 for use as a stream of data output over line 60 for computer implementation.

In the case of the present invention, it is the acceleration experienced by piezoelectric crystals 14, 16 and 18 that is determinative of future actions taken by a computer to which a mouse, or similar device, incorporating the features of the present invention is attached. As discussed above, FIG. 2 depicts what happens for each of the three piezoelectric crystals 14, 16 and 18 of FIG. 1. Thus, there would be three output signals expressed as voltages on lines 30; 30ₓ, 30_{y} and 30_{z}. Detected accelerations xₐ and yₐ 70 and 72, respectively, are combined as described below, and thereafter combined with button and other element state information at 76, akin to the manner in which conventional displacement based status information is used at 56 above. The protocol stream of the present invention is then further combined with zₐ at 78 to generate output signal 80 for instructing a device driver associated with a computer (not shown). Computers with which the present invention is used require device drivers adapted to accept and interpret signal 80.

The present invention has particular utility in detecting motion in three dimensions, but the advantages of the invention may be realized even when only two dimensions are needed. That is, a device in accordance with the present teachings may, as can be seen in FIG. 5, consider the Z dimension as an option and not a necessity. If two dimensional motion detection is desired, only two piezoelectric crystals 14 and 16 need be used to comprise a device which would be plug-in compatible with conventional pointing devices.

While the illustrative preferred embodiment depicts the present invention as used in a conventional mouse housing (10, FIG. 1), the invention is not so limited. Piezoelectric crystals (14, 16, and 18 FIG. 1) may be situated in other housing styles, such as a finger attachable housing. Movement of a user's hand or finger would be sufficient to cause crystal disturbance as described in connection with FIG. 2. Operation of such a wearable pointing device would be the same as that described above. Those skilled in the art will arrive at other implementations of the present invention. Other embodiments require only application tailored device drivers for accepting output signals from the present invention and computing desired placement of a cursor and indicated operations in a conventional manner.

Further, the teaching of the invention is not limited to computer pointing devices. Other applications of the principles include motion detection and measurement in aircraft control yokes, and virtual reality gloves or other garments. The motion of anything that moves may be monitored by incorporating piezoelectric crystals, the disturbance of which due to experienced acceleration may be converted into a representative signal.

Refer now to FIG. 6, a graphic description of the operation of the present invention. FIG. 6 shows the relationship between detected crystal acceleration and traveled distance over time. In FIG. 6 there are two vertical axes representing distance and acceleration. The horizontal axis represents time. Acceleration waveform 90 is representative of that output by filter 44, FIG. 4. It will be appreciated that the rate of acceleration affects the magnitude and shape of curve 98. Curve 98 is a series of line segments A, B and C representing the integration of acceleration 90 events over three time periods, t₁, t₂ and t₃.

At time t1, a piezoelectric crystal such as crystal 14 experiences acceleration from a stop. The integrated distance is shown by line segment A. At time t₂, crystal 14 has reached a steady state and the line segment B is indicative thereof. At time t₃, crystal 14 has decelerated, reached steady state rate of movement, and the results of integration are shown as line segment C.

A user of a motion detection and measurement device in accordance with the invention enjoys better human factors and an enhanced experience because less energy is expended in accelerating as compared with prior art mechanical displacement.

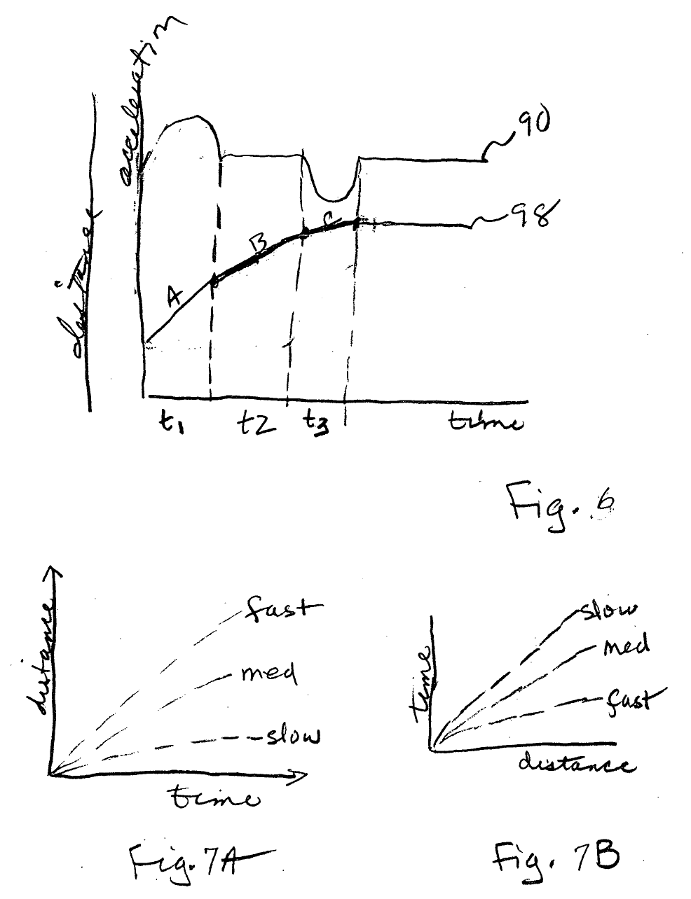

FIG. 7A depicts distance as a function of time. FIG. 7B shows time as a function of distance. In each case it can be seen that precise cursor placement results from properly interpreting crystal disturbance due to acceleration experienced thereby.

FIG. 8 is useful in understanding how the present invention enables position sensing in three dimensions. Thee classical right-hand orthogonal axis set, which has been used throughout in reference to three dimensions, comprises the standard planar horizontal X, vertical Y and Z axes, the last being perpendicular to the plane of X and Y. In FIG. 8, imaginary cube 100 defines a three dimensional space, representing for example a computer screen visible to a user of a game or other generated graphic display. Such a user may desire to move a cursor, or other position indicator, from a current location shown at 102 to a new location 104. A user of a system which includes a pointing device embodying the present invention would then accelerate that device until the new location 104 is reached. The formula d=sᵢt+½at², where d is distance; sᵢ is initial speed; a is acceleration; and t is time, describes the new cursor location 104 in the 3D space of imaginary cube 100.

The formula for acceleration dependent distance is d=sᵢt+½aⁿt², where n is an operational constant and the other values are as above defined. A value of 1 for n is normal. When n has a value <1 there is relatively less cursor movement resulting from pointing device, mouse or other, movement. When n is >1, there is greater relative cursor movement resulting from device movement.

Operational constant n may be 1 for general use, but for a better user experience, n may be varied by scaling acceleration a. If a device in accordance with the present invention is moved a lot, n becomes >1 and the cursor moves quickly. If such a device moves a little, as when zeroing in on a spot to click, the value of n goes to <1 and finer control results. When n=1 is the setting, less fine control results.

The feature here emphasized is cursor distance amplification as a function of acceleration experienced by piezoelectric crystals in a user accelerated pointing device. The above formulas apply to both 3D and 2D location determinations.

While the present invention has been described having reference to a particular illustrative preferred embodiment, it is not limited to the details shown. Rather, the above and other modifications in form and detail may be made without departing from the spirit of the invention as described in the appended claims.

What is claimed is:

1. An apparatus for sensing motion of a computer pointing device, comprising:
a housing manipulatable by a user;
piezoelectric crystals, in said housing, oriented in orthogonal directions relative to each other;
means connected to each crystal for detecting crystal deformation resulting from experienced acceleration; and
means connected to said means for detecting for converting crystal deformation to control signals adapted to locate an object in a desired position.

2. The apparatus of claim 1 wherein said housing is a mouse.

3. The apparatus of claim 1 wherein said housing is adapted for attachment to said user.

4. The apparatus of claim 1 wherein said housing additionally includes:
means for applying acceleration forces uniformly across faces of said crystals.

5. The apparatus of claim 4 wherein said means for detecting comprises:
an excitation means; and
means connected between said crystal and said excitation means for sensing a voltage change arising from crystal disturbance due to experienced acceleration.

6. The apparatus of claim 5 wherein said means for converting comprises:
means for digitizing said voltage change; and
means, connected to said means for digitizing, for integrating said digitized voltage change to find a distance to said desired position.

7. A method for positioning an object in at least two dimensions, comprising the steps of:
providing a user movable housing adapted to contain piezoelectric crystals oriented to correspond to the each of said dimensions;
accelerating said housing;
detecting crystal deformation resulting from experienced acceleration; and
thereafter converting detected deformation to control signals adapted to locate said object in a desired position.

8. The method of claim 7 wherein said detecting step comprises:
electrically exciting each crystal; and
sensing a voltage change arising from crystal disturbance due to experienced acceleration.

9. The method of claim 8 wherein said accelerating step comprises:
applying a force of acceleration evenly across crystal faces, said faces being oriented orthogonally to acceleration direction.

10. The method of claim 9 wherein said converting step comprises:
digitizing said sensed voltage change; and
integrating output from said digitizing step over time to compute distance.

11. The method of claim 10 wherein:
said object is a cursor; and
said desired position is located within a navigable display.

12. A method of determining a desired position in a multi-dimensional configuration comprising the steps of:
providing a plurality of piezoelectric crystals oriented orthagonally to each other;
accelerating said crystals;
detecting a disturbance in each crystal; and
converting each said disturbance into a signal adaptable to be passed to a receiving device.

13. The method of claim 12 wherein said plurality of piezoelectric crystals comprises crystals oriented for sensing acceleration in the x, y and z dimensions.

14. The method of claim 13 wherein the accelerating step is carried out through user manipulation.

15. The method of claim 14 wherein said user manipulation comprises:
moving a housing containing said piezoelectric crystals;

16. The method of claim 15 wherein said moving step comprises:
applying acceleration forces uniformly across faces of said crystals oriented orthogonally to acceleration forces.

17. The method of claim 16 wherein said housing is attachable to a body part of said user.

18. The method of claim 13 wherein said detecting step comprises:
sensing a change in voltage output from each of said accelerated crystals; and
amplifying said voltage change for each crystal.

19. The method of claim 18 wherein said converting step comprises:
digitizing said voltage change for each crystal; and
integrating said digitized voltage for computing a signal representing distance to a user-desired position in three-dimensional space.

20. The method of claim 19 wherein said converting step additionally includes:
passing said integrated signal to a receiving device comprising a navigable display.
